(19) United States
(12) Patent Application Publication
(10) Pub. No.: US 2004/0170486 A1
(43) Pub. Date: Sep. 2, 2004

(54) Toggle

(76) Inventor: Terenci G. DeMeo, Toronto (CA)

Correspondence Address: Elias C. Borges, Suite 406, 1 Eva Road, Toronto, ON, M9C 4Z5, CA

(21) Appl. No.: 10/782,891

(22) Filed: Feb. 23, 2004

Related U.S. Application Data
(60) Provisional application No. 60/450,337, filed on Feb. 28, 2003.

(51) Int. Cl. F16B 21/00

(52) U.S. Cl. 411/340

(57) ABSTRACT

The present invention is a toggle fastener for providing a means to attach a screw or bolt to a drywall wall. The toggle consists of an elongated flexible tube having open opposite first and second ends. The tube is dimensioned to receive the screw or bolt. A pair of wings extend perpendicularly from the first end of the tube. A cylindrical member is mounted to the tube, the cylindrical member having an internal passage, the internal passage dimensioned to permit the cylinder to slide snugly over the tube.

### CROSS REFERENCE TO RELATED APPLICATION

The present application claims priority from provisional patent application serial No. 60/450,337, the entirety of which is incorporated herein by reference.

### FIELD OF THE INVENTION

The invention relates generally to toggles for facilitating the placement of mounting screws on drywall, wall boards, wall paneling or other similar building materials.

### BACKGROUND OF THE INVENTION

When a picture or other heavy object is to be mounted onto a drywall wall, it is possible to simply drive a mounting screw into the wall. Unfortunately, simply driving a screw into a drywall wall is not desirable for several reasons. Firstly, the drywall wall will likely be damaged by the process of driving the screw into the wall. Secondly, the screw will not be strongly anchored to the wall and will fall out if any significant force is applied to the screw. In order to strongly anchor a mounting screw to a drywall wall, a toggle is generally required. One type of toggle consists of a plastic or soft metal tube which is inserted into a pre-drilled hole in the drywall. The screw is then driven into the tube. The tube is configured to expand when the screw is driven into the tube, causing the tube to grip the drywall. This type of toggle is only suitable for light applications since the tube is frictionally held within the pre-drilled hole. Another type of toggle employs a spring biased hinged wing and screw combination. This toggle consists of a spring biased wing which is hinged in its center such that the wing can fold up. The wing is treaded onto a mounting screw or bolt at the hinge. To use this toggle, a hole is first drilled into the drywall. The user then folds up the wing, threads it onto one end of the screw (or bolt) and then inserts the toggle (wing first) into the hole until the wing passes to the inside of the drywall wall. Once inside the wall, the spring biased wing unfolds, preventing it from being forced back out through the hole. This type of toggle enable the mounting screw (or bolt) to be very strongly anchored to the wall. Unfortunately, this type of toggle requires a fairly long mounting screw (or bolt). The longer the mounting bolt, the more awkward it is to use since a long portion of bolt will extend outside of the hole. Also, if the screw is removed from the wing by turning the screw, the wing falls into the wall and is lost. A new toggle will then have to be inserted into the wall.

### SUMMARY OF THE INVENTION

The present invention overcomes the disadvantages of the prior art by providing a toggle fastener consisting of an elongated flexible tube having open opposite first and second ends. A pair of wings extend perpendicularly from the first end of the tube. A cylindrical member is mounted to the tube, the cylindrical member having an internal passage, the internal passage dimensioned to permit the cylinder to slide snugly over the tube.

With the foregoing in view, and other advantages as will become apparent to those skilled in the art to which this invention relates as this specification proceeds, the invention is herein described by reference to the accompanying drawings forming a part hereof, which includes a description of the preferred typical embodiment of the principles of the present invention.

### DESCRIPTION OF THE DRAWINGS

FIG. 1. is a perspective view of the present invention.

FIG. 2. is a perspective view of the underside of the wing portion of the invention.

FIG. 3. is a perspective view of the present invention in its folded orientation being inserted into a wall.

FIG. 4. is a cross-sectional view of the present invention after being inserted into a wall.

FIG. 5. is a side view of the wing portion of an alternate embodiment of the present invention.

FIG. 6. is a perspective view of the wind portion of an alternate embodiment of the present invention.

FIG. 7. is a perspective view of an alternate embodiment of the present invention.

In the drawings like characters of reference indicate corresponding parts in the different figures.

### DETAILED DESCRIPTION OF THE INVENTION

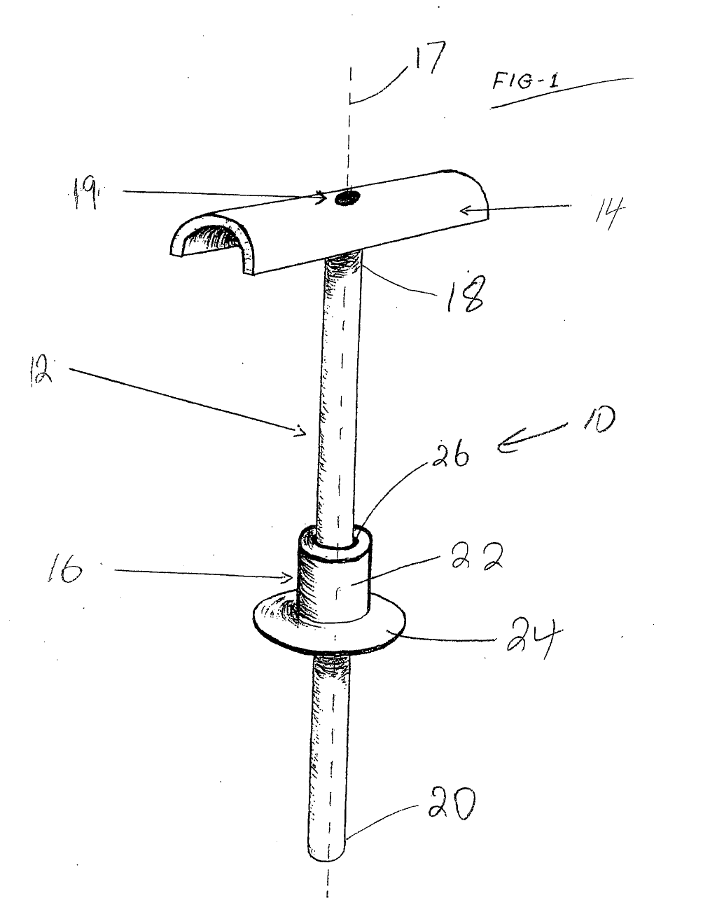

Referring firstly to FIG. 1, the present toggle, shown generally as item 10, consists of an elongated hollow straw (tube) 12, a wing member 14 and a cylindrical washer-nut member 16. Straw 12 is a hollow flexible plastic tube having opposite ends 18 and 20 and longitudinal axis 17. Wing 14 is securely attached to end 18 of straw 12. Wing 14 has an aperture 19 which is formed in the center of the wing. Aperture 19 is co-axial with axis 17 of straw 12. Washer-nut 16 has a tubular nut portion 22 and a substantially flat washer portion 24. Nut portion 22 has an internal passage 26 dimensioned to be slightly greater than the outside diameter of straw 12 such that the straw can be pressure fit into the passage. Washer-nut 16 is slipped onto straw 12 with nut portion 22 oriented towards wing 14. Nut portion 22 has an outside diameter which is greater than the outside diameter of straw 12.

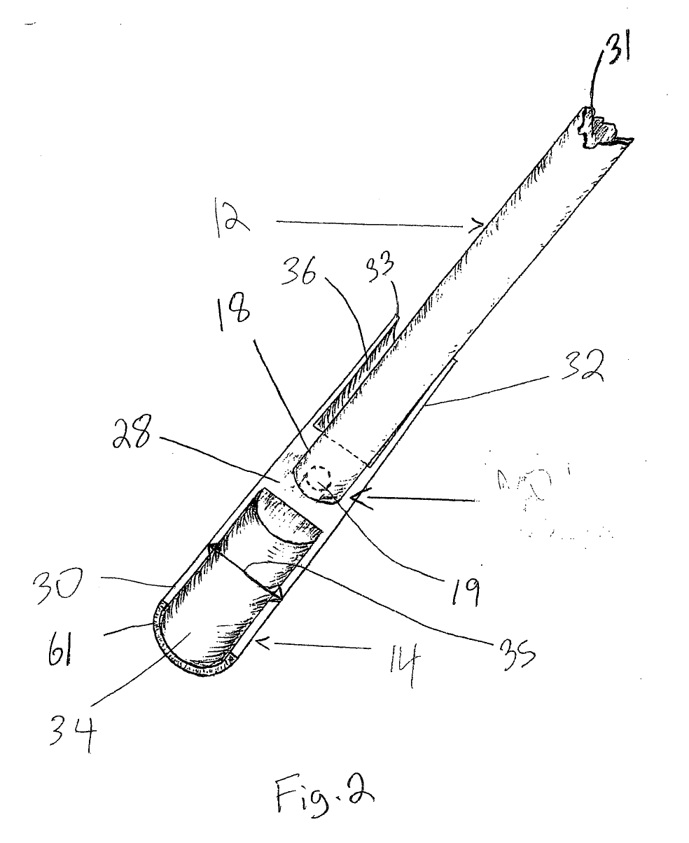

Referring now to FIG. 2, straw 12 is hollow and has an internal passage 31. The inside diameter of passage 31 is dimensioned to permit a mounting screw (not shown) to pass through passage 31. Wing 14 is made of a single piece of material and has hub 28 and arms 30 and 32. Arms 30 and 32 have ends 61 and 33, respectively. Wing 14 has a width 35 which is greater than the outside diameter of straw 12. Wing 14 also has a length between ends 61 and 33 which is greater than the width. Arms 30 and 32 are curved to form concave surfaces 34 and 36 respectively. The inside diameters of concave surfaces 34 and 36 are slightly greater than the diameter of straw 12. Concave surfaces 34 and 36 provide structural strength to wing 14. Straw 12 is firmly attached to hub 28. Aperture 19 passes through hub 28 such that central passage 31 of straw 12 and aperture 19 are continuous. Wing 14 is preferably made of a strong material such as metal or high strength plastic. End 18 of straw 12 is made flexible such that it can be easily bent without breaking. Preferably, straw 12 is made of a resilient yet strong plastic material. If wing 14 is to be made of metal, then straw 12 must then be mounted to hub 28 by means known generally in the art, such as bonding. It is also possible that wing 14 and straw 12 are formed as one continuous piece of injected plastic material.

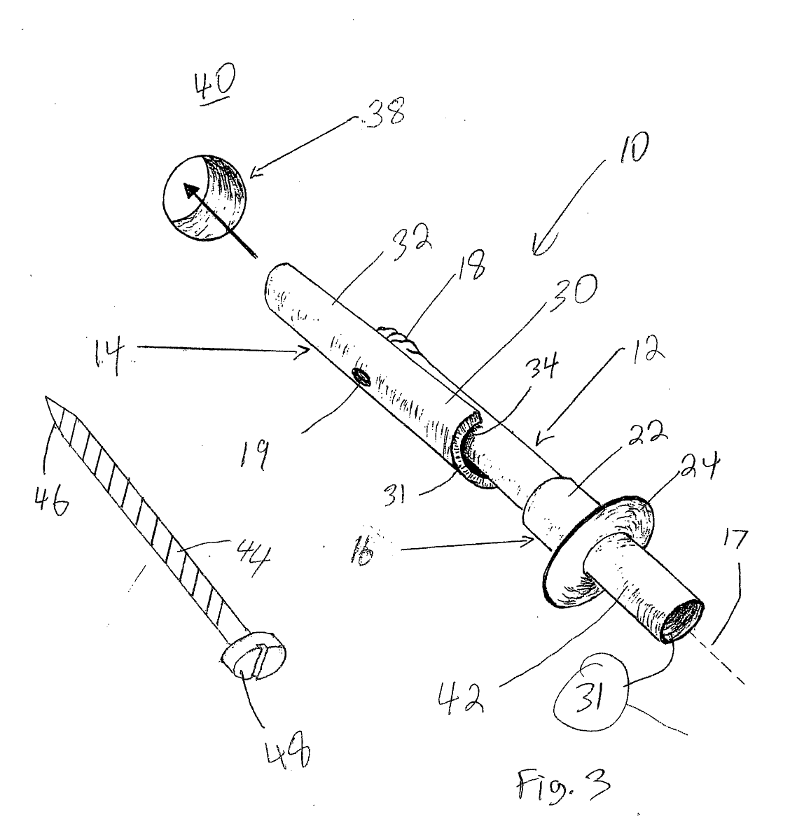

Referring now to FIG. 3, to use toggle 10, a user first drills hole 38 in wall 40. The diameter of hole 38 should be slightly greater than the diameter of wing 14. Toggle 10 is then folded such that it will fit within hole 38. To fold the toggle, end 18 of straw 12 is bent at an angle of approximately 90° such that arm 30 of wing 14 is drawn against straw 12 and the straw is located within concave surface 34. Toggle 12 is then partially inserted into hole 38 by inserting the toggle starting with wing arm 32. Since the diameter of hole 38 is greater than the diameter of wing 14, the wing portion can be fully inserted into the hole. The toggle is further pushed into hole 38 such that nut portion 22 is inserted into the hole. The outside diameter of nut 22 is the same as the diameter of wing 14, hence the nut portion of nut/washer 16 can be inserted into hole 38. The washer portion 24 of nut-washer 16 has a greater diameter than hole 38, so it cannot be inserted into the hole.

It will be appreciated that since end 18 of straw 12 is made of a resilient material, wing 14 will be placed back into a perpendicular orientation relative to the straw when the wing is fully inserted through hole 38 and behind wall 40. When wing 14 is located behind wall 40, the user can then pull on portion 42 of straw 12 which is located past washer portion 24 in order to urge the wing and nut-washer 16 towards each other. The straw may then be trimmed off at portion 24. When wing 14 is located behind wall 40 and nut-washer 16 is positioned in hole 38, the toggle is then ready to receive mounting screw 44. Screw 44 is inserted into straw 12 by passing screw tip 46 into passage 31 and feeding the screw all the way into the straw until tip 46 makes contact with wing 14. It will be appreciated that screw 44 may be a wood screw or any other suitable screw or threaded machine bolt or screw. The very end of tip 46 will pass through aperture 19 of wing 14. The screw may then be turned to thread onto wing 14. The curved arms 30 and 32 provide resistence, allowing screw 44 to be tightened securely to wing 14. Washer portion 24 is dimensioned to prevent screw head 48 from passing through passage 31. Washer 24 also protects the surface of wall 40 from damage when screw 44 is driven into the toggle.

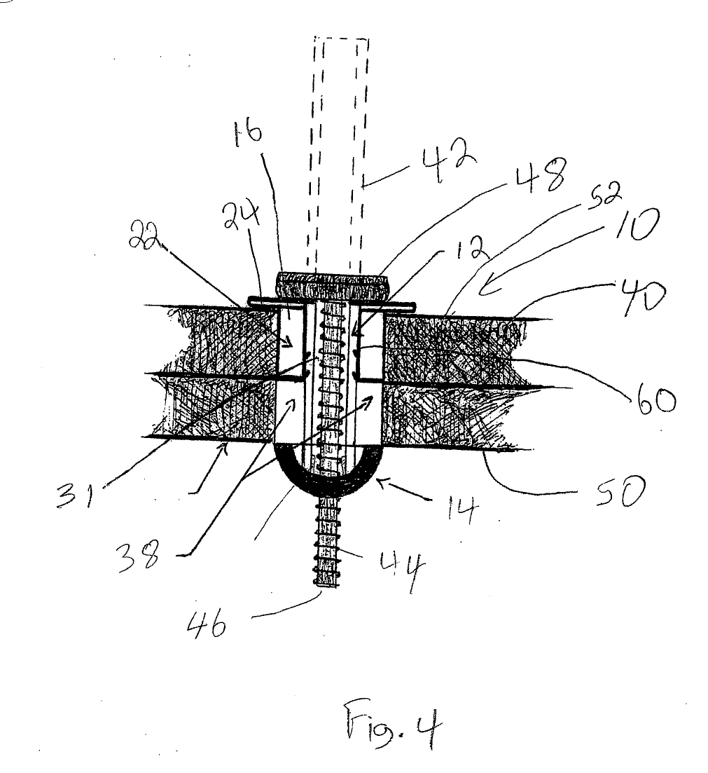

Referring now to FIG. 4, when toggle 10 is positioned in wall 40, wing 14 will be perpendicular to straw 12. Since wing 14 is longer than it is wide, wing 14 cannot be pulled back through hole 38 when the wing is perpendicular to the straw. The user selects the diameter of hole 38 to be slightly greater than the width of wing 14. Since the outside diameter of nut portion 22 is the same as the width of wing 14, the nut portion will fit snugly into hole 38. Nut portion 22 helps to support screw 44 and strengthens the portions of wall 40 adjacent hole 38. Washer 24 not only prevents screw head 48 from passing into passage 31 of straw 12, it also protects surface 52 of wall 40 from damage. Screw 44 can be tightly threaded onto wing 14 because the wing cannot be removed through hole 38 after it is returned to its perpendicular orientation. Since straw 12 still connects both wing 14 and nut-washer 16, screw 44 may be unscrewed from wing 14 and then removed from the toggle without the wing falling. This permits the toggle to be reused after it has been inserted into the wall. The inside surface of nut portion 22 has barb portions 60. Barb portions 60 help to keep straw 12 from accidentally sliding out of the nut portion. In addition, straw 12 is pressure fit within the nut portion to prevent the straw from accidentally sliding out.

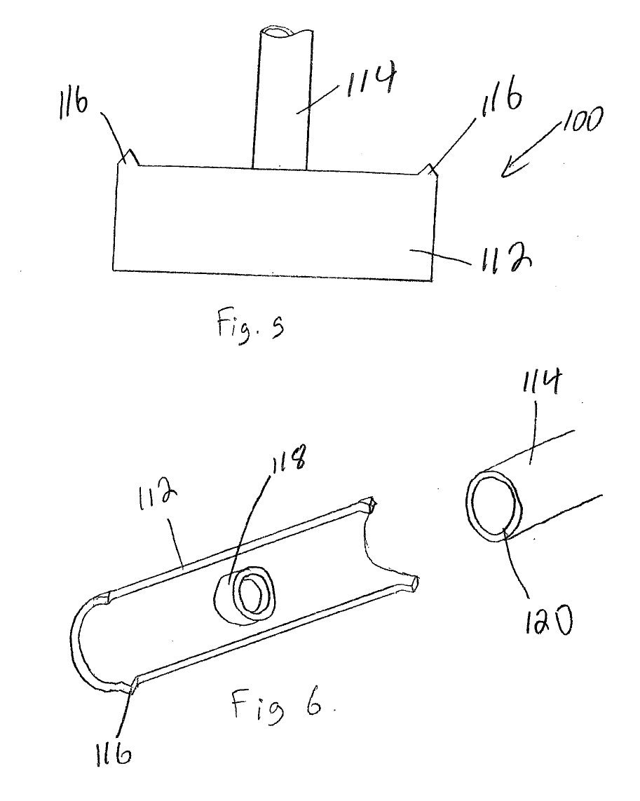

The wing portion of the present invention may be modified to make the toggle easier to assemble and easier to use. Referring now to FIGS. 5 and 6, an alternate embodiment of the present invention, shown generally as item 100, consists of a modified wing 112 and a straw 114. Wing 112 has sharp projecting spikes (fingers) 116 which are located on the ends of the wing and which are oriented back towards straw 114. Spikes 116 are sharp and will permit the wing to bite into the surface of the wall board or other material the toggle is to be used with. Spikes 116 help prevent wing 112 from turning as the screw or fastener is inserted into straw 114. Wing 112 also has a central protrusion 118 which is dimensioned to pressure fit in end 120 of straw 114. Protrusion 118 makes mounting wing 112 to straw 114 relatively simple. A drop of glue (not shown) may be applied to protrusion 118 to maintain a tight bond between the protrusion and end 120 of straw 114. Alternatively, straw 114 may be made of a heat shrinkable material and end 120 of the straw could be heat shrunk onto protrusion 118. Several methods of heat shrinking are currently available, including heat guns and the like. Protrusion 118 is also internally threaded to better allow the screw or nut to be more easily received.

Referring now to FIG. 7, an alternate embodiment of the present invention is shown generally as item 200 and comprises and elongated straw 202 mounted to wing 204 having opposite ends 206 and 208. As in the previous embodiments, washer nut 210 is mounted onto straw 202. Washer nut 210 has nut portion 214 and washer portion 212. Locking portion 216 is mounted to washer portion 212 of washer nut 210 by flexible bridge 220. Locking portion 216 is a short hollow tube having tapered end 217. End 217 has an outside cross sectional diameter slightly smaller than the inside cross sectional diameter of straw 202. Locking portion 216 has an internal passage 219 having an inside diameter sufficient to receive screw/bolt 222. Locking portion 216 is tapered such that end 215 is slightly wider than end 217. Preferably, end 215 is slightly wider than the internal cross sectional diameter of straw 202. Preferably washer nut 110 is one piece construction made of injection molded plastic. Straw 202 has elongated cut out groove 218 extending from tip 226 to point 228 located about two or more centimeters from wing 204.

The present embodiment works substantially the same way as the previous embodiments. The wall to be tapped (not shown) is drilled to form a hole (not shown) and then wing 204 is passed through the drilled hole to the other side of the wall and allowed to spring back into shape. After wing 204 of toggle 200 is positioned behind the wall (not shown) nut portion 214 is inserted into the hole. Locking portion 216 is then grasped and end 217 is inserted into slot 218. Bridge portion 220 is sufficiently long and flexible to permit the locking portion to be so manipulated. End 217 is then inserted through straw 202 and into washer nut 210. Locking portion 216 is then forced further into washer nut 210 thereby trapping a portion of straw 202 between the washer nut and the locking portion. In this way, the straw is locked into place such that the washer nut cannot move relative to the straw. The excess straw may then be trimmed and screw/bolt 222 may be inserted into the washer nut by passing through passage 219.

We claim:

1. A fastener toggle comprising:
a. an elongated flexible tube having open opposite first and second ends,
b. an elongated first member having a central portion and opposite wing portions, the central portion mounted to the first end of the tube,
C. a cylindrical second member having an internal passage dimensioned to receive the tube, the second member mounted to the tube between the first and second ends of the tube.

2. The fastener toggle of claim 1 wherein the central portion of the first member has an aperture, the aperture and tube being coaxially aligned.

3. The fastener toggle of claim 1 wherein the cylinder has a washer portion formed on an end of the cylinder.

4. The fastener toggle of claim 2 wherein the cylinder has a washer portion formed on an end of the cylinder.

5. The fastener toggle of claim 4 wherein the wing portions, the washer portion and the tube have cross sectional diameters, the cross sectional diameter of the wings being slightly greater than the cross sectional diameter of the tube and the cross sectional diameter of the washer portion being greater than the cross sectional diameter of the wings.

6. The fastener toggle of claim 5 wherein the wing portions have an arched profile defining a concave surface having a diameter slightly greater than the diameter of the tube.

7. The fastener toggle of claim 6 wherein the wing portions each have a wing tip, the wing tips each having a projecting spike.

8. A fastener toggle comprising:
a. an elongated flexible tube having open opposite first and second ends,
b. a pair of wings extending perpendicularly from the first end of the tube,
c. a cylindrical member having an internal passage, the internal passage dimensioned to permit the cylinder to slide snugly over the tube.

9. The fastener toggle of claim 6 wherein the cylinder has a washer portion formed on an end of the cylinder.

10. The fastener toggle of claim 9 wherein the wings, the washer portion and the tube have cross sectional diameters, the cross sectional diameter of the wings being slightly greater than the cross sectional diameter of the tube and the cross sectional diameter of the washer portion being greater than the cross sectional diameter of the wings.

11. The fastener toggle of claim 10 wherein the wing portions have an arched profile defining a concave surface having a diameter slightly greater than the diameter of the tube.

12. The fastener toggle of claim 11 wherein the wing portions each have a wing tip, the wing tips each having a projecting spike.

13. The fastener toggle of claim 1 further comprising a short cylindrical third member mounted to the second member by a flexible bridge, the third member having an internal passage, the third member having a cross sectional diameter selected to permit the third member to fit snugly in the tube.

14. The fastener toggle of claim 13 wherein the third member is tapered.
